(19) United States
(12) Patent Application Publication
(10) Pub. No.: US 2016/0290041 A1
(43) Pub. Date: Oct. 6, 2016

(54) Rail Vehicle With Selective External Shading

(71) Applicant: SIEMENS AG ÖSTERREICH, Wien (AT)

(72) Inventor: Thomas BACHMAYER, Wien (AT)

(21) Appl. No.: 15/038,113

(22) PCT Filed: Oct. 13, 2014
(86) PCT No.: PCT/EP2014/071887

§ 371 Date: May 20, 2016

(30) Foreign Application Priority Data
Dec. 4, 2013 (EP) 13195609.6

(51) Int. Cl. E06B 9/40; B61D 25/00

(52) U.S. Cl. CPC E06B 9/40; B61D 25/00; B61D 1/00

(57) ABSTRACT

A rail vehicle with side windows in the passenger compartment, where each side window is allocated a semi-transparent external shading that is arranged on the outside of the rail vehicle.

### CROSS-REFERENCE TO RELATED APPLICATIONS

This is a U.S. national stage of application No. PCT/EP2014/071887 filed 13 Oct. 2014. Priority is claimed on European Application No. 13195609 filed 4 Dec. 2013, the content of which is incorporated herein by reference in its entirety.

### BACKGROUND OF THE INVENTION

1. Field of the Invention

The invention relates to a rail vehicle having a side window in the passenger compartment.

2. Description of the Related Art

When rail vehicles are used in subtropical or tropical climate zones, the influx of solar energy through the windows contributes significantly to undesirable heating of the passenger compartment. Climate control of the passenger compartment to provide a temperature range perceived as pleasant by the passengers requires a large-dimensioned air conditioning system with a correspondingly high level of energy consumption.

In order to reduce the energy influx through the side windows in a location subject to high solar radiation, it is known for rail vehicles to have roller blind systems on the inside of the side windows. Although this provides shading, it does not achieve a satisfactory reduction in the energy influx.

### SUMMARY OF THE INVENTION

In view of the foregoing, it is an object of the present invention to provide a rail vehicle in which solar energy influx through the side windows of the rail vehicle is minimized.

This and other objects and advantage are achieved in accordance with the invention by a rail vehicle in which the solar energy influx is reduced by externally mounted semi-transparent external shading. Semi-transparent means that transparency from the passenger compartment to the outside is reduced, but at the same time a reduction in the solar energy influx is achieved. The semi-transparent external shading is a sheet-like structure composed of opaque and transparent surface sections, i.e., is “half-transparent”. On their side facing away from the window, the opaque (i.e., non-transparent surface sections) have a reflective coating which at least partially reflects incident solar radiation to the outside. As reflection or absorption, as the case may be, occurs at a distance from the window, the heat influx into the passenger compartment is lower. The sheet-like structure therefore acts firstly as a substrate for a reflective coating and can be implemented in different ways, e.g., as a rigid acrylic glass pane or a glass pane having an adhesively attached foil. The foil can be a polarizing foil. However, the external shading can also be of flexible configuring, such as a net, a woven fabric, or a continuous material layer.

A considerable reduction in the influx of solar energy can be achieve particularly if the semi-transparent external shading is disposed at a distance from the external surface of a side window, where the gap formed thereby is provided with at least one air inlet and air outlet opening. By suitably disposing the air inlet/outlet openings, on the one hand, the slipstream can be used to ventilate the gap. The forced air flow ensures that less heat enters the interior of the rail vehicle. Also, when the rail vehicle is stationary, the ventilated gap can cause the air rising in the gap to re-transport at least some of the heating produced by the incident solar radiation to the outside.

As previously stated, the semi-transparent shading can be a fixed plate-like part, but can also be flexibly implemented, e.g., as a roller blind. In both cases it appears advantageous if the external shading does not stand proud of the vehicle outline, but lies flush with the outer skin of the rail vehicle.

In a preferred embodiment, the external shading is formed by a plate or foil that is retained flush with the vehicle outline via spacers. If the spacers are formed by bolts, the external shading is also easily demountable. Depending on the operating site of the rail vehicle, summer and winter operation can then be implemented, i.e., the gap is ventilated in the summer, and not ventilated in the winter. Likewise, a different semi-transparent external shading with respect to the reflective properties and transmittance properties can be used in summer and winter.

In another preferred embodiment, the semi-transparent external shading assigned to a side window is formed by a roller blind system. Here, the roller blind system has at least one roller tube from which a semi-transparent sheet material can be unrolled from a rolled-up state for the purpose of shading a side window. The sheet material can be a plastic mesh, a textile, a foil or a non-woven material.

In order to provide a variable shading effect, such as to enable it to be adapted to suit the intensity of the incident solar radiation, it may be advantageous for the roller blind system to have two roller tubes disposed on opposite sides of a side window. Stronger or weaker shading can be set depending on which section of the material web of differing transparency wound onto the two roller tubes for the purpose of shading is used. Actuation of the roller tubes can be advantageously controlled by an electric drive system that automatically predefines the shading depending on the position of the sun, such as, high opacity when the sun is at its highest at midday.

In an advantageous embodiment in which the sheet material is guided by two guide bars disposed opposite one another at right-angles to the axis of the roller tube, the guide bars are disposed flush with the outer skin of the rail vehicle. This makes the material web better able to withstand the slipstream.

The semi-transparent external shading can be advantageously used as an advertising space. This can be achieved, for example, by imprinting the substrate implemented as a plate or material web with pixels or grid points in the form of a composite print raster.

Because of its flexibility, a polymer is a particularly suitable material for the material web.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference will now be made in the following part of the description to drawings in which further advantageous embodiments, details and further developments of the invention will emerge on the basis of non-limiting examples, in which:

FIG. 1 shows a schematic partial cross section through a rail vehicle passenger compartment having a window that is externally covered in accordance with the invention by semi-transparent external shading;

FIG. 2 shows an embodiment of the invention in which the semi-transparent shading is implemented as a roller blind, where the roller blind is vertically mounted on one side of the window;

FIG. 3 shows another embodiment of the invention in which the semi-transparent shading is implemented as a roller blind system, where the roller blind is vertically mounted on an upper edge of the window; and

FIG. 4 shows an alternative to the embodiment of the invention shown in FIG. 1, where a roller blind system comprising two roller tubes is used.

### DETAILED DESCRIPTION OF THE EXEMPLARY EMBODIMENTS

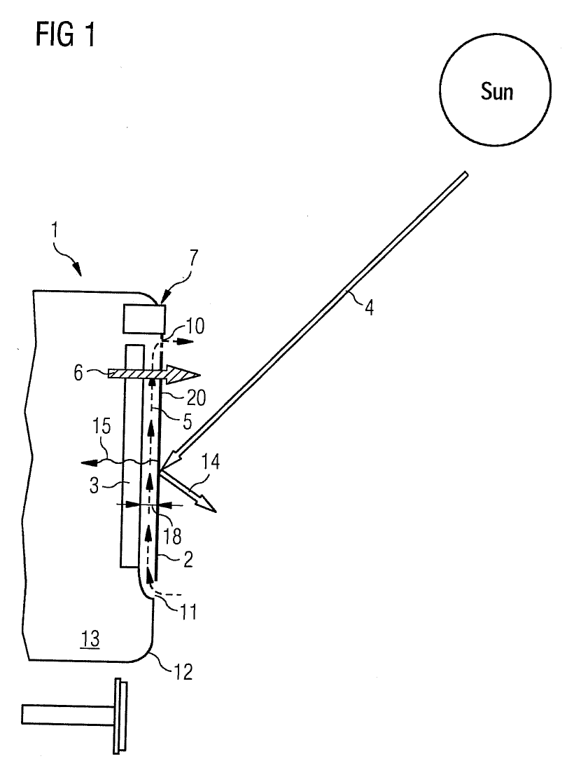

FIG. 1 shows a highly schematic representation of a cross section through the passenger compartment 13 of a rail vehicle 1. Disposed on a side wall is a window 3 that is covered on the outside at a distance 18 from the window 3 by semi-transparent external shading 2. The external shading 2 is sheet-like and consists of opaque and transparent sections. The opaque, i.e. non-transparent surface sections are configured such that solar rays 4 incident thereon do not reach the interior of the passenger compartment 13 but are instead reflected (arrow 14). The external shading is configured such that, as indicated by the arrow 6, the passengers can see through the shading, but the interior 13 of the passenger compartment is selectively shaded from sunlight. A gap 5 is provided between the window 3 and the external shading 2. This gap 5 is ventilated. The ventilation is configured such that the slipstream passes through the gap. When the vehicle 1 is stationary, air at the underside of the window 2 can enter through the opening 11 and exit again through the air outlet opening 10 at the top. As a result, a cooling effect is achieved even when the rail vehicle is standing in a station. As a result, the interior 13 of the passenger compartment is less strongly heated by incident solar rays (see arrow 15 in FIG. 1), which means that the energy consumption for air conditioning is lower. In the embodiment of the invention outlined in FIG. 1, the external shading 2 consists of a roller blind system 7. The roller blind system 7 essentially consists of a wrap-around roller on which strip-like flexible external shading is wound. Driven, for example, by a motor and lateral guides that are not shown in detail in FIG. 1, the external shading 2 implemented as a material web 20 can be lowered and raised again. The advantage of this is that the shading effect can be predefined by an automatic control system, such as, depending on the position of the sun. In the case of manual operation, the external shading 2 of the rail vehicle 1 can be adjusted seasonally or on a daily basis. As shown in FIG. 1, the semi-transparent external shading 2 is flush with the outer skin 12 of the rail vehicle 1.

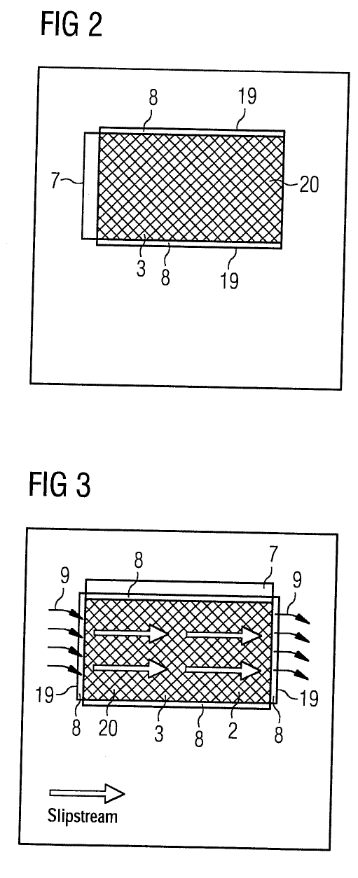

FIGS. 2 and 3 show a plan view of different arrangements of the roller blind system 7 onto the side wall of a rail vehicle. In FIG. 2 the roller of the roller blind system 7 is disposed at the side of the window 2. In FIG. 3 the roller of the roller blind system 7 is disposed at the top of the window 3. The arrows 9 indicate the slipstream which in FIG. 3 enters from the left through an air inlet opening 8, flows through the gap 5, and exits again at an air outlet opening 8. As a result, a cooling effect is achieved. The material web of the roller blind system is implemented as a net in the exemplary embodiments shown in FIGS. 2 and 3. The material web 20 is laterally guided in guide bars 19.

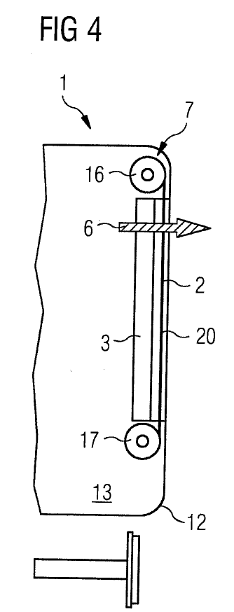

FIG. 4 shows another embodiment of the invention in which the roller blind system 7 has a first, upper roller tube 16 and a second, lower roller tube 17. This makes it possible to vary the degree of shading depending on which piece of material of the web 20 is used to cover the window surface 3. The two roller tubes 16, 17 are powered by an electric drive controlled by a higher-level control system (not shown in detail) of the rail vehicle. Self-evidently, the roller tubes 16 and 17 can also be disposed differently or manually operated, so that the material web is not wound vertically but in a horizontal direction.

A major advantage of the disclosed embodiments of the invention is that the influx of solar energy into the passenger compartment 13 of a rail vehicle 1 can be reduced in a comparatively simple way. A significant aspect is that the air conditioning system of the rail vehicle can be of less expensive and more economical design when using the rail vehicle 1 in subtropical or tropical climate zones. This means lower energy and operating costs for the operator of the rail vehicle.

Another advantage is that the semi-transparent selective external shading can be advantageously used as advertising space. The advertising space is not limited to the size of the window, but can have different advertising content corresponding to the length of the deployed, flexible material web in the case of the embodiment having two roller tubes.

Although the invention has been illustrated and described in detail by the above mentioned preferred embodiments, the invention is not limited by the examples disclosed. Other variations may be inferred therefrom by those skilled in the art without departing from the scope of protection sought for the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A rail vehicle with side windows in the passenger compartment, wherein each side window is assigned semi-transparent external shading which is disposed on an exterior of the rail vehicle.

12. The rail vehicle as claimed in claim 11, wherein the assigned semi-transparent external shading is disposed at a distance from an outer surface of a side window; and wherein a gap formed thereby is provided with at least one air inlet opening and air outlet opening.

13. The rail vehicle as claimed in claim 12, wherein the semi-transparent semi-transparent external shading assigned to the side window is a rigid plate retained by spacers and disposed integrally flush with an outer skin of the rail vehicle.

14. The rail vehicle as claimed in claim 12, wherein the semi-transparent external shading assigned to a side window comprises a roller blind system having at least one roller tube from which a semi-transparent sheet material is unrolled from a rolled-up state to shade a side window.

15. The rail vehicle as claimed in claim 14, wherein the sheet material completely covers an assigned side window and is disposed flush with the outer skin of the rail vehicle when in an operating position.

16. The rail vehicle as claimed in claim 14, wherein the roller blind system includes two roller tubes disposed on opposite sides of the side window.

17. The rail vehicle as claimed in claim 14, wherein the sheet material is guided by two guide bars disposed opposite one another at right-angles to an axis of the two roller tubes; and wherein each of the two guide bars are disposed flush with the outer skin of the rail vehicle.

18. The rail vehicle as claimed in claim 15, wherein the sheet material is guided by two guide bars disposed opposite one another at right-angles to an axis of the two roller tubes; and wherein each of the two guide bars are disposed flush with the outer skin of the rail vehicle.

19. The rail vehicle as claimed in claim 16, wherein the sheet material is guided by two guide bars disposed opposite one another at right-angles to an axis of the two roller tubes; and wherein each of the two guide bars are disposed flush with an outer skin of the rail vehicle.

20. The rail vehicle as claimed in claim 13, wherein the transparency of the sheet material varies when viewed across the surface.

21. The rail vehicle as claimed in claim 20, wherein a pattern is formed by the varying transparency of the sheet material.

22. The rail vehicle as claimed in claim 13, wherein the sheet material is made of plastic.

23. The rail vehicle as claimed in claim 14, wherein the sheet material is made of plastic.
